(19) United States
(12) Patent Application Publication
(10) Pub. No.: US 2016/0195064 A1
(43) Pub. Date: Jul. 7, 2016

(54) METHOD FOR PRODUCING A COMPOSITE STRUCTURAL PART, COMPOSITE STRUCTURAL PART AND WIND POWER PLANT

(71) Applicant: WOBBEN PROPERTIES GMBH, Aurich (DE)

(72) Inventor: Alexander Hoffmann, Emden (DE)

(21) Appl. No.: 14/909,923

(22) PCT Filed: Aug. 5, 2014
(86) PCT No.: PCT/EP2014/066833

§ 371 Date: Feb. 3, 2016

(30) Foreign Application Priority Data
Aug. 5, 2013 (DE) 10 2013 215 381.3

(51) Int. Cl. F03D 1/06; F03D 1/00

(52) U.S. Cl. CPC F03D 1/0675; F03D 1/001; F03D 11/04; F03D 1/0691

(57) ABSTRACT

A production method and to a composite structural part, in particular for a wind power plant, with a multiplicity of at least two-component composite moldings, a first component being formed from a shaping core material and a second component being formed as part of a joining layer. According to the invention, the shaping core material is formed, in conformity with the shape of a prism, as a prismatic body with a polygonal basic area, a polygon of the basic area having a base and an angle to the base which amounts to between 30° and 60°, and a multiplicity of prismatic bodies are joined together, a functional orientation of the joining layers being formed at meeting legs, in such a way that the joining layer runs at an angle of 30°-60° to a base area of the prisms.

### BACKGROUND

1. Technical Field

The invention relates to a method 1 for producing a composite structural part for a wind power plant, with a multiplicity of at least two-component composite moldings, a first component being formed from a shaping core material and a second component being formed as part of a joining layer. The invention also relates to a corresponding composite structural part and a sandwich structural part, to a rotor blade element and to a wind power plant having such a composite structural part.

2. Description of the Related Art

Composite moldings are moldings comprising two or more interconnected materials which are produced as bodies with fixed geometric dimensions. The materials occurring in the composite have mostly functional properties, in particular for the specific purpose as regards to their field of use. Substantive and sometimes also geometric properties of the individual components are important for the properties of the stock obtained. This makes it possible for components having different properties to be connected to one another, with the result that the composite materials afford broad possibilities of use. The properties required for the final product can be set, as required, by the choice of different initial substances for the components.

A composite structural part mostly has properties which constitute an optimized behavior of the composite molding under the action of load. The properties may be assignable, for example, in terms of a certain strength, rigidity or extensibility. Under the action of load, a composite molding should present an optimized behavior of the composite in relation to an individual component of the composite. The development of composite moldings tends, in principle, towards optimizing the required properties in combination with the service life in order to withstand load lasting for many years. Particularly in the case of rotor blades and other parts of a wind power plant, high and sharply varying load actions are brought to bear, which, moreover, when part of a wind power plant increases in size, likewise increase. Rotor blades, in particular, should withstand the static loads and also the dynamic loads which arise.

Composite structural parts may be produced in various ways. Thus, rotor blades of a wind power plant are nowadays manufactured mainly from composite fiber materials in which reinforcing fibers, mostly as a mat, are embedded in a matrix, mostly glass-fiber-reinforced plastic. A rotor blade is mostly produced in a half-shell sandwich type of construction. To an increasing extent, for example, carbon-fiber-reinforced plastic is employed. The properties required here are, on the one hand, a low weight along with relatively high structural strength, and also various degrees of hardness and a tensile strength which is tailored to the load action. In any event, in principle, and from the above standpoints, glass-fiber-reinforced or carbon-fiber-reinforced materials could supersede the previous use of balsa wood in view of their optimized strength.

The typical use of composite structural parts is to integrate these in a sandwich type of construction; in this case, a plurality of layers having different properties are embedded in order to obtain an appropriately established structural part. In structural terms, both the materials and the orientation or alignment of the individual components are important. The core material may consist of materials, such as, for example, paper, cardboard, plastics, metals, balsa wood, corrugated sheeting, plastics, foams and further shaping components, mostly in conjunction with structural cavities. The object of the core material is to transmit both tensile forces and shear forces and to support the covering layers.

Fiber-reinforced components or composite structural parts have fibers distributed in a laminate material, the fibers being oriented in at least one specific direction in order to achieve the higher-grade properties of the composite fiber material. In any event, in principle, a distinction can be made between three acting phases in the material: fibers having high tensile strength, an initially in any event relatively soft embedding matrix and a boundary layer connecting the two components. The fibers may typically consist of glass, carbon, or ceramic, but also of aramid, nylon fibers, concrete fibers, natural fibers or steel fibers. The embedding matrix itself, mostly polymers, has material-specific flexural strength, holds the fibers in position, transmits stresses between them and protects the fibers from external mechanical and chemical influences. The boundary layer serves for the transmission of stress between the two components. The problem with fiber-reinforced composite structural parts is the possible formation of tears of the respective fibers in the stressed regions of the structural part; these may occur, above all, because of moments of flexion due to increased dynamic mechanical load.

However, fiber-reinforced components or composite structural parts, in each case with a specific number of fibers in a laminate or matrix material, considerably improve the mechanical performance of the respective components. For material-specific parameters, such as shear resistance and flexural strength, and also the concentration of the fibers in the defined direction, the mechanical supporting properties of the respective components can be individually set in a targeted way, particularly with regard to the tensile strength of the respective composite. One factor for the rating of composite fiber materials is the volume ratio between the fibers and matrix. The higher the fraction of fibers, the stronger, but also the more brittle, the composite material becomes. In addition to the tensile strength, the shear resistance and flexural strength may also play a part in the event that the composite is subjected to pressure. Moreover, in particular, it is known, in principle, that, by what is known as a sandwich-like composite construction with a core and with one or two covering layers, in conformity with the principle of a T-girder, a high mechanical rigidity of the composite can be achieved by means of a moderately shear-resistant core and at least one comparatively flexion-resistant covering layer, the composite nevertheless being capable of being implemented in a lightweight type of construction.

It is known that foamed thermoplastics are used as a core layer in sandwich-type composites or composite structural parts. Foamed plastic boards may be produced, for example, by means of an extrusion method. For demanding uses, sandwich-type composites are required, in which thermoplastics are provided with fibers which have a high degree of strength and rigidity, in particular shear resistance and flexural strength for compressive and shearing loads. The increase in the material characteristic values may take place linearly by adding together the layered composites. However, too high a mass of composite structural parts may cause the individual structural part to have a high specific weight. It is therefore desirable, in addition to the choice of material, also to provide structural measures, by means of which a property requirement of the composite structural part can be appropriately adapted and/or improved.

EP 2 307 193 discloses a sheet-like structural element, a foam body consisting of body segments which are arranged next to one another in one plane and are connected to one another to form the foam body and which have sheet-like weld seams at their abutting faces, and at the same time the weld seams are interrupted by recesses standing at a distance from one another. In this case, the sheet-like structural element is, in particular, board-like and is used preferably as a core or core layer in sandwich-type composites, for example in rotor blades of wind power plants.

EP 1 308 265 discloses a structural part of elongate type of construction, which is characterized in that layered boards parallel to one another consist of a fiber/plastic composite. An improved composite structural part which is suitable for use in wind power plants is desirable.

In the priority application, the German Patent and Trademark Office has searched the following prior art: DE 1 504 768 A, DE 603 03 348 T2; EP 2 307 193 B1 and EP 1 308 265 A1.

### BRIEF SUMMARY

One or more embodiments of the invention is to specify a composite structural part, a wind power plant and a method, which are improved in terms of the prior art, and at least to address one of the problems described above. At least, an alternative solution to a solution known in the prior art is to be proposed. In particular, a composite structural part and a method for producing a composite structural part are to be configured in such a way as to offer a simplified and nevertheless further-developed possibility of optimizing the structural part with regard to rigidity and/or strength. In particular, the composite structural part and the method for producing a composite structural part are to be implementable in an improved way. In particular, the composite structural part and the method are to make it possible to have long-term rigidity and/or strength opposed to the load actions, preferably with both the flexural strength and the shear resistance being increased.

One embodiment is directed to a method for producing a composite structural part for a wind power plant, with a multiplicity of at least two-component composite moldings, a first component being formed from a shaping core material and a second component being formed as part of a joining layer.

A composite structural part made from two components can be optimized with regard to the required material properties by a combination. In this case, solutions are found which relate to both components; thus, composite structural parts with, for example, a directional fiber within an embedding matrix may be provided in order to counteract higher loads. A composite structural part is manufactured in such a way that a connection in the manner of a sandwich construction or similar constructions is possible, and, in particular, by adhesive bonding or joining together, in particular hot joining or adhesion. It is recognized that a composite structural part acquires improved composite-specific material properties when, in addition to the choice of materials, the structural shape of the composite structural part is designed to the effect that forces in the composite can be absorbed in an improved way.

According to one embodiment of the invention, there is a provision whereby the shaping core material is formed, in conformity with the shape of a prism, as a prismatic body with a polygonal basic area, a polygon of the basic area having a base and an angle to the base which amounts to between 30° and 60°, and a multiplicity of the prismatic bodies are joined together, a functional orientation of the joining layers being formed at joining surfaces, in such a way that the joining layer runs at an angle of 30°-60° to a base area of at least one of the prisms adjoining one another.

Advantageously, the longitudinal and transverse orientation of fibers or threads or suchlike strands are transferred to the geometric shape of the core; in particular, a longitudinal and transverse orientation is additionally assisted, using composite fiber structural parts. The composite structural part has correspondingly, under the action of load, such as tension or pressure, but also under shear stress, a macro-mechanical strength which arises from the oriented rigidity of the joining layers and the combination of the materials.

While the shaping core material stipulates a functional orientation of the joining layers, which is able to remove tensile forces in different directions according to a parallelogram of forces, along the legs a structural part can be joined which can absorb shear and torsional stresses and can counteract the corresponding load actions, such as tension or pressure, and the corresponding flexural strength. Joining at the respective angles of functional orientation which are stipulated by the legs turns out to be an advantageous measure which, if appropriate, can also be influenced by a choice of the angle.

A three-dimensional stress tensor can be counteracted. The polygonal basic area stipulates the different orientation possibilities and forms the basic scaffold for the interlacing of the joining layers which counteract the load actions. The structural features mentioned in the prior art are tailored to the force normal (corresponding to a uniaxial stress tensor), to the effect that a force acts perpendicularly to the surface. Furthermore, however, a three-dimensional load action can be made possible by the force distribution, as a function of the arrangement and of the joining masses. The concept makes it possible to have an orientation of the core material which counteracts the strengths, in that the joining layers run obliquely to the main extent of the structural part and therefore perform the function of additional reinforcing structural measures to form a composite structural part which is correspondingly increased in strength.

By the choice of the size of the basic area, the material properties can be varied to the effect that the material core sizes can be set with regard to shear strength and shear resistance by the size of the area and therefore by the volume fraction of the shaping core. By the legs being joined in a specific geometric arrangement, with the corresponding angle progression and with a corresponding volume fraction, the compressive strength and the rigidity can be set, in order thereby to generate, overall, a constructive and material-specific composite structural part. In particular, the structural arrangement of the shaping core materials in respect of their legs leads to an optimized and improved type of construction of a composite structural part which can thus have increased strengths.

One embodiment of the invention proceeds from a composite structural part for a wind power plant, with a multiplicity of at least two-component composite moldings, a first component being formed from a shaping core material and a second component being formed as part of a joining layer. According to one embodiment of the invention, there is provision whereby the shaping core material is formed, in conformity with the shape of a prism, as a prismatic body with a polygonal basic area, a polygon of the basic area having a base and an angle to the base which amounts to between 30° and 60°, and

a multiplicity of the prismatic bodies are joined together, a functional orientation of the joining layers being formed at joining surfaces, in such a way that the joining layer runs at an angle of 30°-60° to a base area of at least one of the prisms adjoining one another.

Another aspect of the invention also leads to a composite structural part in the form of sandwich structural part. A preferred development is a sandwich molding which contains at least one of the composite structural parts as core material, with at least one covering layer. This development also includes the construction of a sandwich molding in which the composite structural part includes a force-absorbing top ply which is held with clearance by means of a core material. The present development thus makes it possible to integrate the above-mentioned property combinations with finite maximum values, along with a low weight, in a sandwich structural part which overall, as a result of the linear growth of the nominal values, counteracts with high fatigue strength in the case of higher load actions.

Furthermore, another aspect of the invention also leads to a composite structural part in the form of a rotor blade element. A development involves a rotor blade element, using at least one composite structural part as core material. In particular, an optimized composite structural part is integrated into the construction of a rotor blade and, in particular, also into the semi-monocoque type of construction typical of the rotor blade, in order to achieve optimized fatigue strength and compressive strength. Preferably, the rotor blade is optimized in terms of the pulling or gravitational forces occurring during operation. In this case, using this composite structural part, tear minimization or minimized tear propagation is achieved on account of the shaping core as thermoplastic.

One embodiment of the invention leads to a wind power plant, in particular with a rotor blade which has at least one composite structural part. Since ever greater loads are to be expected because of the ever increasing dimensioning of the rotor blades and due to the structurally dynamic behavior of the rotor blades, these loads can be absorbed in an improved way by means of the composite molding according to the set material-specific characteristic values and the structurally joined-together composite structural part. The materials used hitherto in terms of their material-specific properties are limited because of the stipulated mass and can therefore be replaced by those materials which additionally have structural measures for an increase in strength.

Further advantageous developments of the invention can be gathered from the subclaims and, in particular, specify advantageous possibilities of implementing the broadened concept within the scope of the set object and with regard to further advantages.

In particular, it has turned out to be advantageous that the joining of a plurality of prisms at the joining surfaces forms a functional orientation of the joining layer at an angle of virtually 45° to a transverse axis of the prism and/or prisms. In particular, this applies to a functional orientation of the joining layer at an angle of 45°, that is to say the angle in the base of the polygon laying at 45° within a variance of +/−10°, preferably +/−5°. There is preferably provision whereby a functional orientation of the joining layers, which is formed at the joining surfaces, runs at an angle of 45°, within a variance of +/−10°, preferably +/−5°, to the base area of the prism and/or prisms.

Within the scope of an especially preferred development, the shaping core material, conforming to the shape of a cylindrical body, is formed with a polygonal basic area.

However, in a variant of a development, the shaping core material may also be joined into a prismatic body in the form of a three-dimensional polyhedron, the angle of the polyhedron faces amounting to 30°-60°, preferably a polyhedron face having an angle of 45°, within a variance of +/−10°, preferably +/−5°, to the base area and/or transverse axis. In particular, in a composite structural part, the shaping core material is joined to form a three-dimensional polyhedron, the angle of the polyhedron faces amounting to 30°-60°, preferably an angle of 45°, to the base. In this development, the structural measure for absorbing the prevailing forces is implemented by a corresponding polyhedral formation. The legs present here can easily be joined together structurally and be folded one to the other according to the geometry. In this case, this development is a possibility for constructing a layer system in that further planes are built on the base areas and the action of forces is dissipated according to the leg orientation.

In particular, a composite structural part provides as a second component a functional orientation of fibers as a sheathing of the shaping core material with an angle of 30° to 60°, preferably an angle of 45°. The development affords an additional advantageous consolidation of the composite structural part in terms of shear and torsional stresses. A structural solution of the three-dimensionally shaping core material and also the sheathing with a specific fiber orientation can achieve relatively high compressive strengths and counteract a high load action. The prevailing three-dimensional stress tensor is counteracted, on the one hand, by the three-dimensional orientation of the strength-increasing joining layer and, on the other hand, by the functional orientation of the fibers which is integrated in the joining layers. The load limit of the structural part in terms of its service life in the case of static and dynamic load actions upon a structural part which has been manufactured in such a way is increased especially advantageously.

For a preferred development, a composite structural part is provided, in which the shaping core material and the joining layer give a cross-sectional pattern of hexagons joined in a sheet-like manner, and joining surfaces form a functional orientation of the joining layers at an angle of 30° to 60° to the transverse axis, the transverse axis being oriented parallel to the base of the hexagonal basic area. The development of the principle, known per se, of honeycomb materials, especially high strength with regard to dynamic and static loads can be achieved by means of a hexagonal construction. This advantageous structure, in conjunction with the materials employed, can be used especially for high, in particular dynamic, load actions. Moreover, the shape, described here, of the structurally shaping core material makes it possible to process the joining together at the said angle in a simple way and offers a comparatively large network of joining layers which allows a distribution of forces.

In particular, in a composite structural part, the shaping core material has at least one component of the group acrylonitrile-butadiene-styrene, polyamide, polyacetate, polymethylmethacrylate, polycarbonate, polyethyleneterephthalate, polyethylene, polypropylene, polystyrene, polyetheretherketone and polyvinylchloride.

Within the scope of the preferred development, a component for the shaping core material can be used which has specific material characteristic values in terms of the load action. In this case, the sum of a plurality of shaping core materials can reach the desired maximum composite-specific characteristic value. The combination of the various materials makes it possible to set locally the material parameters with regard to forces taking effect, in addition to the local geometric force distribution. Consequently, in the case of various or a plurality of thermoplastics, a structural part-specific and construction-specific material characteristic value can be set, which furthermore, due to the structural measure of the succeeding legs and corresponding joining layer, constitutes an optimized solution for a high force action. Preferably, in the composite structural part, the second component joins together the composite consisting of a plurality of prisms into a thermoplastic deformable structural part with comparatively increased rigidity in relation to the shaping core.

This and other developments take advantage of the fact that the joining layer has increased shear strength between the individual shaping core materials, in order to allow the resistance of a body to elastic deformation caused by corresponding force distribution. The increased shear strength required here leads to increased strength within the structural part and contributes to a distribution of the forces according to the geometric and material-specific parameters. In this case, the shear strength may be higher than that of the shaping core material, since the oriented joining layers assist the transfer of the corresponding shear and torsional faces. The force or the material component of the joining layer may exhibit, in terms of the load action, a correspondingly increased shear resistance, coupled with a certain flexural and torsional rigidity.

In particular, a composite structural part may be provided, in which the shaping core material is reinforced by additionally internal functionally directed fibers. Force distribution can preferably take place at the joining layers and consequently absorb tangential forces, so that predetermined tearing or breaking points are counteracted.

Functionally directed fibers which reinforce the shaping thermoplastic can optimize this in terms of its material-specific parameter. Fibers, threads and such like strands can be oriented in such a way that they absorb the corresponding forces and counteract these. Consequently, both in macro-mechanics and in micro-mechanics, a possibility can be forwarded for counteracting load actions and high dynamic load peaks according to structural and layer-specific solutions.

In particular, fibers or threads or such like braided, knitted or woven structures may be introduced into a joining layer and can thus absorb high shear and torsional forces. The acting loads, which are apportioned in a multi-axial manner and span a surface parallelogram in the plane, are also absorbed here by means of the structural feature of the geometric orientation of the joining layer. In this case, on the one hand, by the polygons being varied a composite structural part can be constructed which can be put together in any way in terms of width and height and which can absorb locally differently occurring forces by means of correspondingly geometric solutions. In this case, the structural features are the features in which the legs touch one another in such a way that they form an angle of between 30° and 60° or a preferred angle of 45°. This preferred angle of 45° means that the shear and torsional forces occur at the 45° angle. On the other hand, the combination of materials for the core material and fiber may advantageously be utilized, so that here, moreover, in addition to the possibility of a geometric solution, it is also possible to have a correspondingly oriented material solution. Joining takes place via the legs and, according to the material employed, forms a corresponding strength-increasing and rigidity-increasing layer which has the fibers and which can absorb forces under the action of load with high fatigue strength. The transfer of forces and distribution take place via the shaping core material which can increase the ductile character as a function of the volume.

In particular, the second component can be introduced in the form of a mat and join together the shaping core. By mats being introduced, it is possible for prismatic bodies to be simply folded together, in order thereby to form the said functionally oriented legs by means of two or more folded-together prismatic bodies, in particular polyhedra or cylindrical bodies. In this case, due to the geometric shape of the shaping core material, the adopted solution is a simple and cost-effective production method which, moreover, provides an improved property in terms of the individual materials. Functional orientation is achieved here, in terms of the set property profiles, by means of the mats. In this case, these mats are a functional integral part of the composite structural part and can increase the strength correspondingly.

The distribution of fibers preferably at an angle of 45° can, at this angle, counteract loads, typically optimized in the area thereby defined, in an improved way and have a markedly strength-increasing effect. It was recognized that dynamic loads cause, above all, triggered tears, also called fatigue tears, which occur typically at an angle of 45° to the surface normal. By the fibers being oriented, the formation of tears can be reduced in such a way that a higher fatigue strength can be presupposed.

Preferably, in a method for producing a composite structural part, the shaping core material is extruded. The production of the geometric shape of the thermoplastic can take place by means of a cost-effective and simple method. By means of extrusion, a strand of the thermoplastic mass can be pressed continuously under pressure out of the shaping orifice, in this case the shaping orifice having the corresponding leg orientation. Extrusion gives rise to a corresponding body of any desired length which can thus be produced according to the application. By means of the set process variables, a cost-effective, simple and rapid production of the geometric thermoplastics can be afforded by this method.

A braiding-like fiber system is basically to be interpreted broadly as any type of strand system which has a certain variability with regard to intercepting fibers oriented with respect to one another. It is preferably a braidwork or braiding, in which a plurality of strands made from pliant and, to that extent, as such flexible material, comprising fiber material, are looped one in the other, or a knit, in which pliant and, to that extent, as such flexible material, comprising fiber material, is interlinked; also stitch-forming thread systems, such as knits, are possible. Furthermore, weave-like structures are also possible, in which the strands, although to a lesser extent, but preferably possibly, are guided completely or partially at right angles or approximately at 90° to one another, preferably have at an intersection point a fiber angle which preferably amounts to between 10° and 90° and which preferably amounts to between 30° and 60°, and preferably the fibers are oriented with respect to one another at a fiber angle of around 45° with a variance range of +/−10°, or, in the case of another specific fiber angle, are oriented with respect to one another with a variance range of +/−5°.

In particular, those types of a strand systems are therefore especially preferred, the fiber angle of which can, moreover, be set variably, in particular is automatically set variably, depending on the size and shape of the shaping core material to be introduced. A flexible and variably shapeable braiding-like fiber system with a variable fiber angle is therefore especially preferred. Certain fiber systems are especially conducive to this property, such as, for example, in particular, a braiding-like fiber system which is selected from the group consisting of braidwork or knits.

Exemplary embodiments of the invention are described below by means of the drawings, in comparison with the prior art which is likewise illustrated by way of example. The exemplary embodiments are not necessarily intended to be illustrated true to scale, instead the drawing is given in diagrammatic and/or slightly distorted form and is explained, as expedient. With regard to additions to the teachings which can be seen directly from the drawing, reference is made to the relevant prior art. In this case, it must be remembered that any modifications or changes to the form and detail of an embodiment may be carried out, without deviating from the general idea of the invention. The features of the invention which are disclosed in the description, in the drawing and in the claims are essential to the development of the invention both individually and in any combination. Moreover, all combinations of at least two features disclosed in the description, in the drawing and/or in the claims come within the scope of the invention. The general idea of the invention is not restricted to the exact form or detail of the embodiment shown and described below or is not restricted to a subject which would be limited in comparison with the subject claimed in the claims. When dimensional ranges are given, values lying within the said limits are to be disclosed, here too, as limit values and are to be employable and capable of being claimed, as desired. Further advantages, features and details of the invention may be gathered from the following description, from the preferred exemplary embodiments and from the drawing.

### BRIEF DESCRIPTION OF THE SEVERAL VIEWS OF THE DRAWINGS

In particular, in the drawing:

FIG. 1A shows a diagrammatic illustration of the composite structural part in a preferred embodiment, the shaping core being illustrated as a prism with a polygon as basic area;

FIG. 1B shows a diagrammatic illustration of the composite structural part in a preferred embodiment, the shaping core being illustrated as prisms with different geometric basic areas;

FIG. 2 shows a diagrammatic illustration of the joined prisms with a polygonal basic area, additional sheathing being illustrated;

FIG. 3 shows a diagrammatic illustration of the shaping core of a preferred embodiment, the thermoplastic being illustrated as an elongate tube with a round cross section and with corresponding sheathing;

FIG. 4 shows a diagrammatic illustration of the composite structural part in the form of a folded-together polyhedron;

FIG. 5 shows a diagrammatic illustration of the cross section of a composite structural part, the embodiment possessing a honeycomb structure in the cross-sectional plane;

FIG. 6 shows a simplified cross-sectional illustration through a rotor blade;

FIG. 7 shows a wind power plant;

FIG. 8 shows a flow chart of a preferred embodiment of a production method.

### DETAILED DESCRIPTION

In FIG. 1 to FIG. 8, for the sake of simplicity, the same reference symbols have been used for identical or similar parts or parts having identical or similar functions.

FIG. 1A shows a detail of a composite structural part 1001 in a first embodiment, which, in this detail, is configured in such a way that at least two-component composite moldings in the form of two prismatic bodies 10.1 10.2, here two prisms with an isosceles trapezoidal basic area G, are formed. The joining layer 20, with dark hatching here, is oriented at an angle of 45°; that is to say, this is to be measured as 45° in relation to the depicted transverse axis Q with respect to the base B of the trapezoidal basic area G. The shaping core material of the prismatic bodies 10.1 10.2 is here any free selectable thermoplastic with material-specific properties, which, moreover, by being joined together, acquires a strength which is caused by the joining layer 20. In this case, by the choice of the joining material and the selected volume fraction of the joining layers, a load-specific mechanical strength which can be adapted to the corresponding load actions can be achieved.

FIG. 1B shows a detail of a composite structural part 1002 in a second embodiment, which, in this detail, is formed as composite moldings with prismatic bodies 10.1 10.2 having a trapezoidal basic area 11, 12 and with a prismatic body 10.3 having a triangular basic area 13. The cylindrically prismatic bodies 10.1, 10.2, 10.3 to be designated here as prisms, are joined together at their legs, here the functional orientation of the joining layer running, at the transverse axis Q, at the angle of 45° to the base area BF of at least one of the prisms adjoining one another. The material and volume of the joining layer 20 are selectable, as required, and are identified by the hatching. The sketch, diagrammatic here, shows the functional orientation of the joining layer. A structure opposed to the force can thus be implemented by the geometry of the shaping core material.

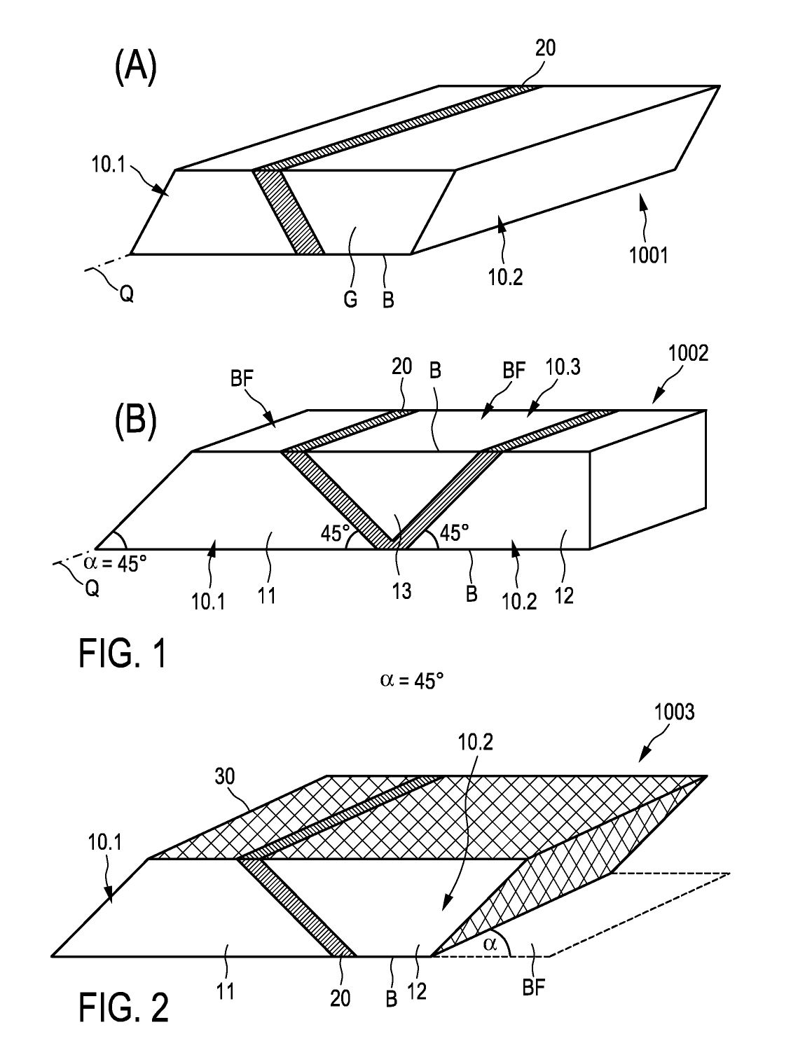

FIG. 2 shows a detail of a composite structural part 1003 in a third embodiment, which, in this detail, joins together as a composite body two cylindrically prismatic bodies 10.1 10.2 to be designated as prisms. The prisms have in each case an identical trapezoidal basic area 11, a surface of the prism being covered by a second component, forming a braiding like or weave-like fibrous covering 30, as part of a joining layer, the fibers of which are oriented. These fibers oriented according to the acting forces can thus bring about additional strength and rigidity in the plane of the joining layers. In this case, both the macro-mechanics and the micro-mechanics of the composite structural part can be designed in an optimized manner by means of the structural execution of the joining layer and the orientation of the additional covering.

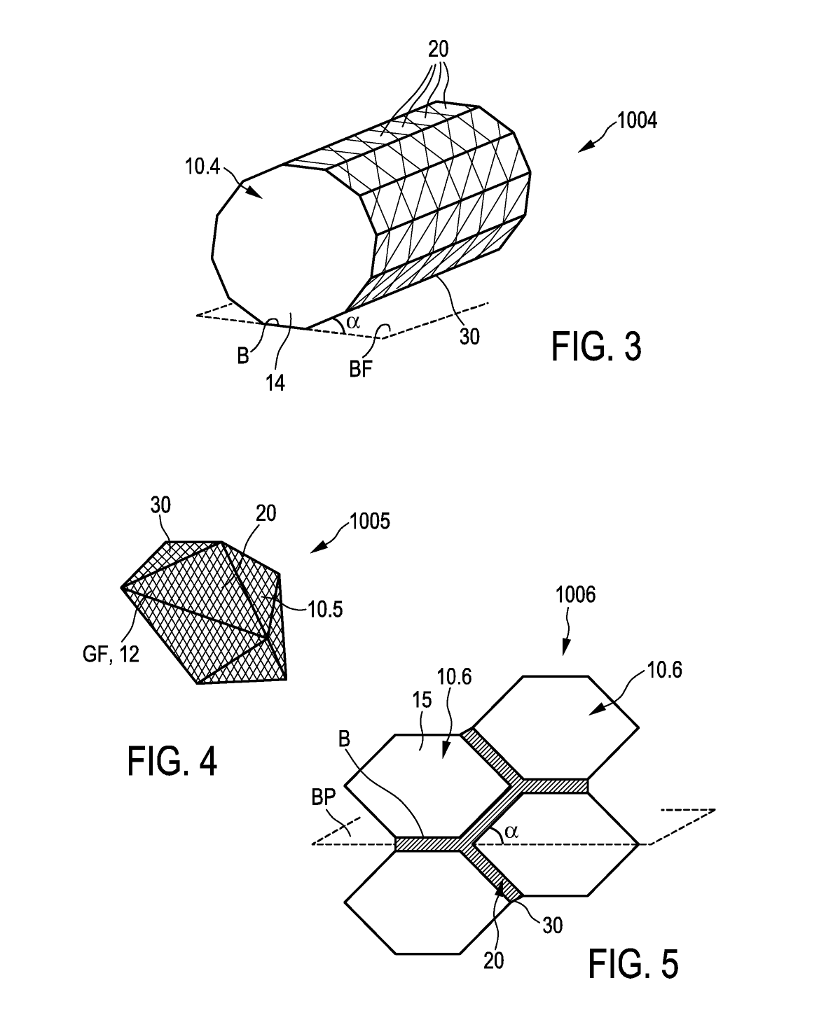

FIG. 3 shows for a composite structural part 1004, in a fourth embodiment, a composite body with a cylindrically prismatic body 10.4, to be designated as a prism, here with a basic area GF in the form of a dodecagon 14; that is to say, angled with a base B and with a correspondingly small angle α of a joining layer to the base B. Here, the prism is sheathed with a second component, forming a braid-like or weave-like fibrous covering 30, as part of a joining layer; to be precise, here with functionally oriented fiber orientation. The sheathing can be implemented, using a braided tube which has within it additionally oriented fibers. As a result of the sheathing of this cylindrically prismatic body 10.4 with an almost circle-like, but polygonal basic area, not only can a close-meshed network of joining layers 20 be formed, but, in addition to the large volume fraction, the strength can also be increased by an additional orientation of the fibers.

This type of execution shows that, for the sheathing, a tube can be used which is ideally adapted to a cross section of a circle, so that in this case sheathing with directed orientation can be established by means of small edges of the polygon, in such a way that they give rise to an increased strength of the composite structural part; the oriented assemblage of a multiplicity of such composite moldings into one composite structural part 1004 is nevertheless easily possible.

FIG. 4 shows for a composite structural part 1005, in a fifth embodiment, a composite molding with a three-dimensionally prismatic body 10.5, to be designated as a prism, in the form of a polyhedron. A composite structural part 1005 could also be illustrated which is composed of composite bodies in the form of prisms with triangular basic areas GF, 12. In this case, a joining layer 20 constitutes a material component which has the strength in which, on account of its orientation, surrounds the shaping core along the directed legs in a substantively integral manner. This type of composite structural part can be produced in a simple way, since joining can take place simply by the folding of identical geometric prisms, in which joining layers a fiber material may be, but does not have to be, provided, thereby forming a covering 30, for example, of the type explained above.

FIG. 5 shows in cross section a detail of a composite structural part 1006 in a sixth embodiment, formed by joining together a plurality of cylindrical or three-dimensional identical prismatic bodies 10.6, to be designated as a prism, which are joined together by means of a joining layer 20 with a covering, so that, in cross section, a genuine honeycomb structure is obtained. Honeycomb structures have high strength, and corresponding dynamic and static loads can be absorbed. The choice of prisms with a hexagonal basic area and the simultaneous orientation of the legs in a selected angular range of 30°-60° to the base B or to the base area BF give rise to a honeycomb structure which can counteract a high load action by virtue of the orientation and selection of the corresponding joining layer. Consequently, by means of a honeycomb structure, increased strength can be achieved for the composite structural part 1006.

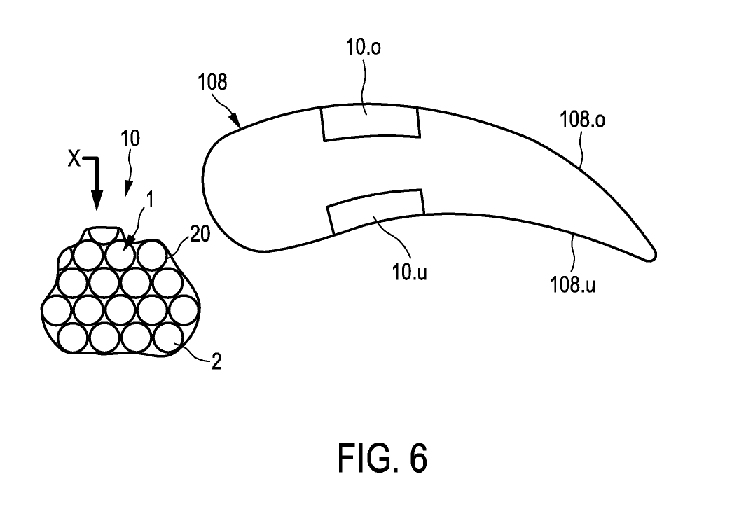

FIG. 6 illustrates a rotor blade 108 for a wind power plant 100 in simplified form in cross section. This rotor blade 108 comprises an upper half-shell 108.o and a lower half-shell 108.u, there being provided as reinforcement in these shells carrying structures 10.o and 10.u which can absorb and remove the loads acting on the rotor blade. These carrying structures may be formed by rotor blade elements, for example in a sandwich type of construction, or by the said composite structural parts 1001, 1002, 1003, 1004, 1005, 1006, in order precisely to absorb these corresponding loads. The detail X of FIG. 6 shows such a carrying structure 10 with a multiplicity of composite moldings 1 made from a core material 2, surrounded by a flexible braiding-like fiber system 20 which here, for example, is assembled in the closest possible packing to form a composite structural part 1001, 1002, 1003, 1004, 1005, 1006 for the carrying structure 10.

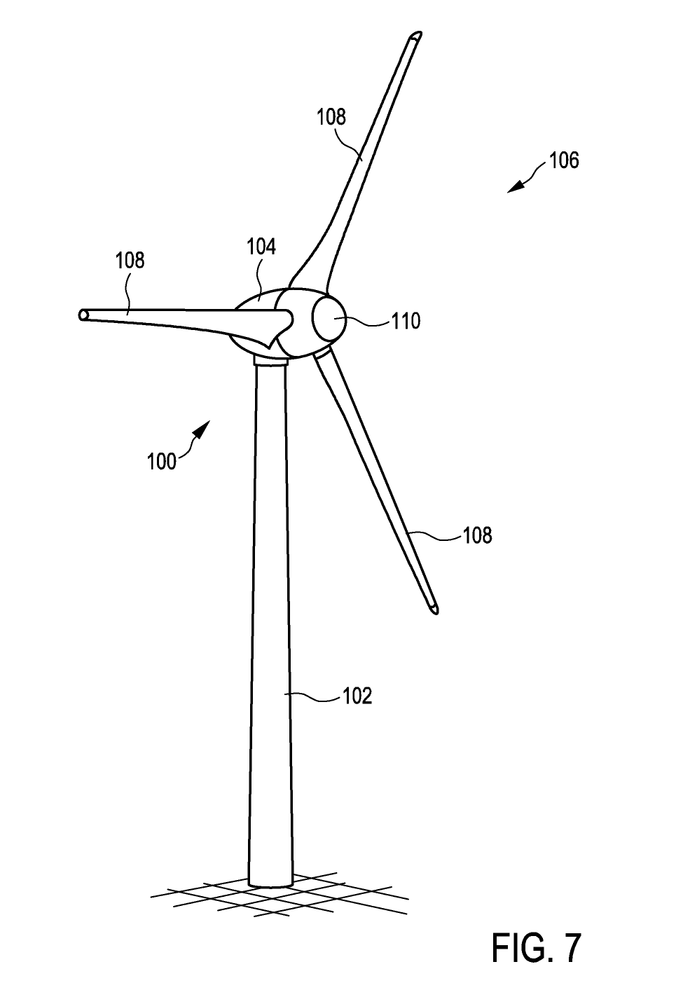

FIG. 7 shows a wind power plant 100 with a tower 102 and with a gondola 104. Arranged on the gondola 104 is a rotor 106 with three rotor blades 108, for example in a similar way to the type of rotor blade 108 in FIG. 4, and with a spinner 110. During operation, the rotor 106 is set in rotational motion by the wind and thereby drives a generator in the gondola 104.

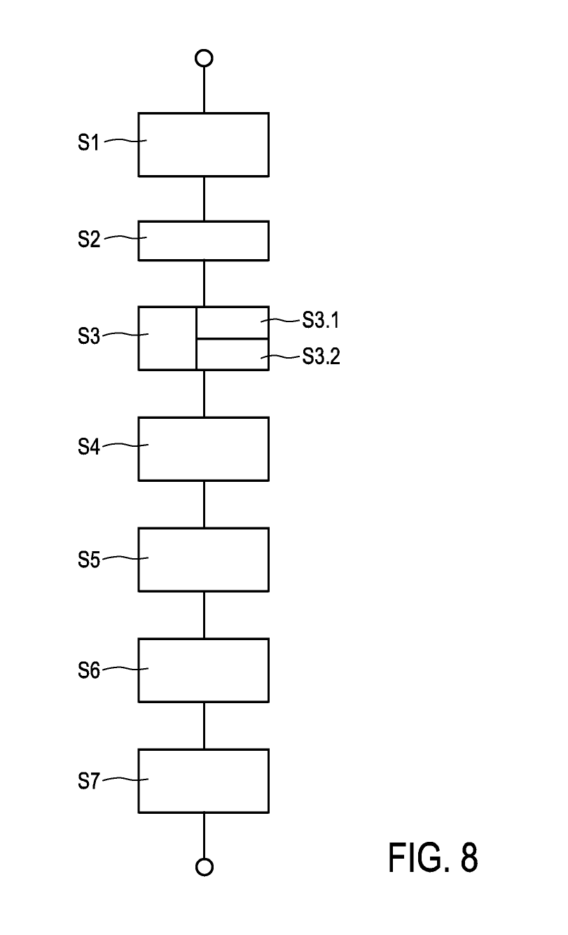

FIG. 8 shows in the manner of a flow chart a preferred embodiment of a production method for a composite structural part 1001, 1002, 1003, 1004, 1005, 1006 or an assemblage of a multiplicity of composite moldings 1 into a composite structural part 1001, 1002, 1003, 1004, 1005, 1006 for a carrying structure 10, for introduction into a rotor blade 108 of a wind power plant 100. In a first step S1, a thermoplastic and, in a step S2, a composite fiber semi-finished product in the form of a braiding, preferably as a mat or braided tube, are made available in the way explained above.

In a third step S3, the thermoplastic, as shaping core material, is produced as a continuous strand and, in a step S4, can be divided, as required, into a multiplicity of composite moldings; to be precise, in conformity with the shape of a prism, is formed as a prismatic body with a polygonal basic area, a polygon of the basic area having a base and an angle to the base which amounts to between 30° and 60°.

In a first variant, in step S3.1, the thermoplastic consisting of a granulate mixture can be delivered to an extruder and at the outlet of the extruder can be introduced directly as a soft strand into a braided tube.

The braided tube has intersecting fibers which have a fiber angle of 45° at an intersection point, and this braided tube is drawn around the still soft shaping core material when this cools. The soft shaping material is thereby consolidated around or on the braided tube or on the fibers of the latter, so as to give rise to a composite between the braided tube and the thermoplastic, with the braided tube, if appropriate, being completely and in any case partially, but not necessarily, on the outside of the latter; the soft shaping material may remain within the contours of the braided tube or else penetrate through the braiding completely or partially outwards; that is to say, in the latter case, swell out and, if appropriate, even lay itself on the outside around the braided tube again and surround the latter.

In the present case, a multiplicity of prismatic bodies may even be joined together as composite bodies to form a composite structural part, a functional orientation of the joining layers being formed at meeting legs or joining surfaces, in such a way that the joining layer runs at an angle of 30°-60° to a base area of at least one of the prisms adjoining one another.

A similar process may be carried out with a braided mat. In a second variant, in a step S3.2, the thermoplastic consisting of a granulate mixture can be delivered to an extruder and at the outlet of the extruder be made available as a soft strand and divided up. The multiplicity of prismatic bodies thus obtained can be joined together, with or without an interposed mat, a functional orientation of the joining layers being formed at joining surfaces, in such a way that the joining layer runs at an angle of 30°-60° to a base area of at least one of the prisms adjoining one another. Preferably, for this purpose, the composite moldings are folded one onto the other; even with a braided mat 30 which is interposed, that is to say which lies in an adjoining layer 20, this process and subsequent hot joining become comparatively simple.

The second component, defined in general in the subject of the application, as part of a joining layer 20, may be a braided mat 30 or a hot seam, in particular, according to these variants of the embodiment.

In the way shown, for example, in the detail X of FIG. 6, the multiplicity of composite moldings may be assembled in a step S5 into a carrying structure.

In a step S6 the carrying structure can be introduced into a half-shell of a rotor blade 108 or into another part of a wind power plant 100. In the present case, the half-shells are assembled into a rotor blade blank and undergo further production steps until, in a step S7, the rotor blade can be mounted on a wind power plant 100 of the type shown in FIG. 7.

1. A method comprising:
producing a composite structural part for a wind power plant, wherein the composite structural part includes a plurality of at least two component composite moldings, a first component being formed from a shaping core material and a second component being formed as part of a joining layer, wherein:
the shaping core material is formed, in conformity with the shape of a prism, as a prismatic body with a polygonal basic area having a base and a side, wherein an angle between the side and the base is between 30° and 60°, and
a plurality of the prismatic bodies are joined together, a functional orientation of the joining layers being formed at meeting surfaces, in such a way that the joining layer extends at an angle of between 30° and 60° to a base area of at least one of the prisms adjoining one another.

2. The method according to claim 1, wherein the angle to the base of the polygon lies at 45° within a variance of +/−10°.

3. The method according to claim 1, wherein a functional orientation of the joining layers is formed and extends at an angle of 45°, within a variance of +/−10° to the base area of the prisms.

4. The method according to claim 1, wherein the shaping core material is formed, in conformity with the shape of a cylindrical body, with a polygonal basic area.

5. The method according to claim 1, wherein the second component is formed in the shape of a mat, the mat being introduced between a first and a second prismatic body and being connected to the shaping core of the prismatic bodies.

6. The method according to claim 1, wherein the second component has a covering of the shaping core material, and has a functional orientation of fibers with an angle of 30°-60° to one another.

7. The method according to claim 1, wherein the shaping core material is made available by extrusion.

8. The method according to claim 1, wherein the shaping core material is joined into a prismatic body in the form of a three-dimensional polyhedron, the angle of the polyhedron faces amounting to 30°-60°.

9. A composite structural part for a wind power plant, the composite structural part comprising:
a plurality of at least two-component composite moldings, a first component being formed from a shaping core material and a second component being formed as part of a joining layer, wherein:
the shaping core material is formed, in conformity with the shape of a prism, as a prismatic body with a polygonal basic area, a polygon of the basic area having a base and an angle to the base that is between 30° and 60°, and
a plurality of prismatic bodies are joined together, a functional orientation of the joining layers being formed at joining surfaces, in such a way that the joining layer runs at an angle of 30°-60° to a base area of at least one of the prisms adjoining one another.

10. The composite structural part according to claim 9, wherein the second component, as a covering of the shaping core material, has a functional orientation of fibers with an angle of 30°-60° to one another.

11. The composite structural part according to claim 9 wherein:
at least one of the shaping core material and the functional orientation of the joining layers forms a sheet-like cross-sectional pattern of hexagons, and
joining surfaces are joined together in a sheet-like manner, of the functional orientation of the joining layers run at an angle of 30°-60° within a variance of +/−10° to a base area of the prisms, the base area being oriented parallel to the base of a hexagon.

12. The composite structural part according to claim 9, wherein the shaping core material contains at least one component of the group: acrylonitrile-butadiene-styrene, polyamides, polyacetate, polymethylmethacrylate, polycarbonate, polyethyleneterephthalate, polyethylene, polypropylene, polystyrene, polyetherketone and polyvinylchloride.

13. The composite structural part according to claim 9, wherein the composite structural part is joined together via the second component, by a thermoplastic matrix including a plurality of prismatic bodies, into a deformable structural part having comparatively increased shear resistance.

14. The composite structural part according to claim 9, wherein the shaping core material is reinforced by additional internal, functionally directed fibers.

15. The composite structural part according to claim 9, wherein the composite structural part is in the form of a sandwich structural part for a wind power plant, using a multiplicity of composite moldings to form a core structural part, wherein the core structural part is covered at least on one side by at least one covering layer.

16. The composite structural part according to claim 9, wherein the composite structural part is in the form of a rotor blade element for a rotor blade of a wind power plant, using a multiplicity of composite moldings to form a core structural part, wherein the core structural part is surrounded by at least one rotor blade covering layer.

17. A wind power plant comprising:
a tower,
a gondola, and
a rotor with a rotor hub and a number of rotor blades, wherein at least one of the rotor blades, the tower, the gondola, the rotor hub has a composite structural part according to claim 1.

18. The method according to claim 8, wherein the angle of the polyhedron faces is 45°, within a variance of +/−10°.

19. A method comprising:
producing a composite structural part for a wind power plant, the composite structural part including at least two component composite moldings and a joining layer, the component composite moldings being formed from a shaping core material, wherein:
the shaping core material is shaped as a prismatic body with a polygonal basic area having a base and a side, wherein an angle between the side and the base is between 30° and 60°, and
the joining layers having joining surfaces at an angle of between 30° and 60° to a base area of at least one of the prisms adjoining one another.
